(19) United States
(12) Patent Application Publication
(10) Pub. No.: US 2017/0245466 A1
(43) Pub. Date: Aug. 31, 2017

(54) WATER BOTTLE CAP DISPENSER DEVICE

(71) Applicant: Hope Adams, Buena, NJ (US)

(72) Inventor: Hope Adams, Buena, NJ (US)

(21) Appl. No.: 15/595,855

(22) Filed: May 15, 2017

Related U.S. Application Data
(63) Continuation-in-part of application No. 14/510,103, filed on Oct. 8, 2014, now abandoned.

(51) Int. Cl. A01K 7/06; B65D 41/62; B65D 47/04; B65D 41/04

(52) U.S. Cl. CPC A01K 7/06; B65D 41/04; B65D 41/62; B65D 47/04

(57) ABSTRACT

A human water bottle with a threaded top is used to dispense water though an attachment sleeve over a ball to a pet while they lick the ball. An attachment sleeve is attached to the threaded top. The ball is set between a top and bottom inner surface of the sleeve. The ball has dimples for larger surface.

The ball rolls or bounces while being licked. Then water flows from the bottle through the inner volume of the sleeve and around the bottom and top surface of the ball to the animal during licking. A cap is screwed on to an outer surface of the sleeve, to protect the ball. The cap has a key chain and protrusion feature. An adaptor can be screwed into the bottom threads of the sleeve having threads at its other end matching bottles having different threads.

The present application is a Continuation-In-Part Application and claims benefit of Continuation-In-Part application Ser. No. 14/510,103 filed on Oct. 8, 2014 which claims the benefit of U.S. Non-Provisional patent application Ser. No. 13/469,086 filed on May 10, 2012 which claims the benefit of U.S. Non-Provisional patent application Ser. No. 12/715,059 filed on Mar. 1, 2010 which claims the benefit of U.S. Provisional Patent Application 61/156,517 filed on Mar. 1, 2009, all disclosures are incorporated by reference.

### FIELD OF THE INVENTION

The present invention generally relates to a water bottle cap dispenser device. More specifically, the invention is a water bottle cap dispenser device that safely hydrates an animal or a pet from the threaded top of a water, filled common human water bottle using an adaptor having a licking ball.

### DESCRIPTION OF THE RELATED ART

Currently water bottles, openings and caps are designed for humans and human consumption. Many times animals such as dogs, cats and other pets may benefit from receiving and drinking water from a human water bottle, because they are available in any location or on any trip. A water bottle that may accommodate a person's animal such as a dog, a cat or other pet would be a benefit to the animal and the person who owns the animal, since the animal has to drink water often when a water bowl is not available.

### BRIEF SUMMARY OF THE INVENTION

The present invention generally relates to a water bottle cap dispenser device. More specifically, the invention is a water bottle cap dispenser device that is more sanitized to safely hydrate an animal or a pet using human bottles that more available than pet water bowls.

The water bottle cap dispenser device is utilized in combination with a water bottle having a plurality of threads and without a human water bottle cap.

It is an object of the invention to provide a water bottle cap dispenser device that may be easily assembled and disassembled and transferred to many types of human water bottles commonly bought and sold in any store.

It is another object of the invention to provide a water bottle cap dispenser that operates so that any bubbles that are created flow upward to fill the emptying area of the emptying water at the inverted bottom end of the bottle.

It is also an object of the invention to provide a water bottle cap dispenser device for pets that is utilized in combination with a human water bottle having a threaded bottle top opening to dispense water to an animal or a pet. The device has an attachment sleeve threadably removable from or attached to the threaded bottle top and a spherical dispersion ball that is set between a top inner surface and bottom inner surface of the attachment sleeve so that the ball never comes loose from the sleeve. The ball is held so that the ball can roll or bounce or bob while the pet licks the ball with his tongue. The ball is held above the top inner surface. The attachment sleeve can be two parts joined by threads or glue or all one piece. Water flows from the attached the water bottle opening through an inner part of the sleeve and around the bottom and top surface of the ball to the animal during roll or rotation caused by licking. Rotation or roll also occurs when the pet and his tongue moves in and out of his mouth. More water flows to the pets tongue as it moves up and down causing the ball to bob or bounce. Bobbing occurs because the bottom inner surface holding the ball is looser or has space. Bobbing occurs because the plastic material of the bottom inner surface is softer. Bobbing occurs because the bottom inner surface has a circular trough structure to capture and release extra water, which creates pressure, making the bottom inner surface more flexible. The water is allowed to have even greater flow to the pet along a larger surface of the ball via dimples or depressions or scratches added all around the normally spherical ball. There maybe a cap that is threaded and removably attached to an outer surface of the attachment sleeve, to cover the ball and stop the water flow, while the device is not in use. The cap has a key chain feature and protrusions to hold the ball tighter making a tighter seal to stop the water flow. In addition an adaptor can be screwed into the bottom threads of the attachment sleeve having differently sized threads at its other end for attachment to a human water bottle having differently sized opening and threads. Additionally, the plastic material used in the manufacture of the cap dispenser or ball may be impregnated with a substance having meat flavor or smell or combination thereof.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a view of how a pet uses and operates the water bottle cap dispenser.

FIG. 2 illustrates an exploded side view of a water bottle cap dispenser device, in accordance with one embodiment of the present invention.

FIG. 3 illustrates an exploded side view of the water bottle cap dispenser having a cap, in accordance with one embodiment of the present invention.

FIG. 4 illustrates an exploded side view of an attachment sleeve section supporting a top portion of a rolling dispersion ball, in accordance with one embodiment of the present invention.

FIG. 5 illustrates an exploded side view of an attachment sleeve section providing an adaptor function, in accordance with one embodiment of the present invention.

FIG. 6 illustrates a close up side view of a dispersion ball having concave dimples and rough surface, in accordance with one embodiment of the present invention.

FIG. 7 illustrates an exploded side view of an attachment sleeve section supporting a bottom portion of a dispersion ball, in accordance with one embodiment of the present invention.

FIG. 8 illustrates an exploded side view of a cap having stop protrusions, in accordance with one embodiment of the present invention.

FIG. 9 illustrates a side perspective view of a cap having a top area for a key chain hole, in accordance with one embodiment of the present invention.

FIG. 10 illustrates a top perspective view an attachment sleeve section supporting a bottom portion of a dispersion ball, in accordance with one embodiment of the present invention.

### DETAILED DESCRIPTION OF ILLUSTRATIVE EMBODIMENTS

Various aspects of the illustrative embodiments will be described utilizing terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

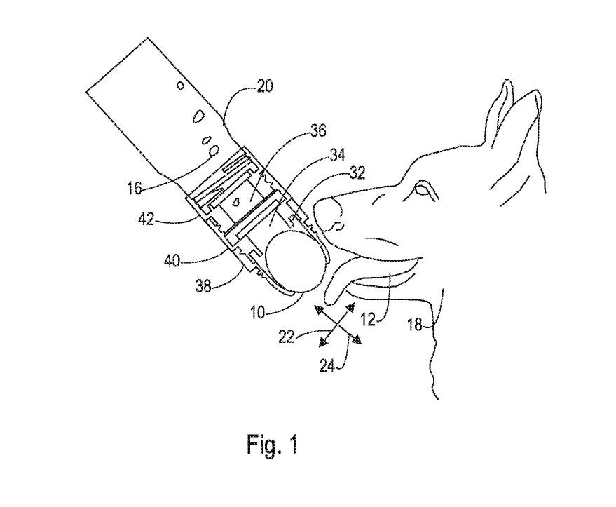

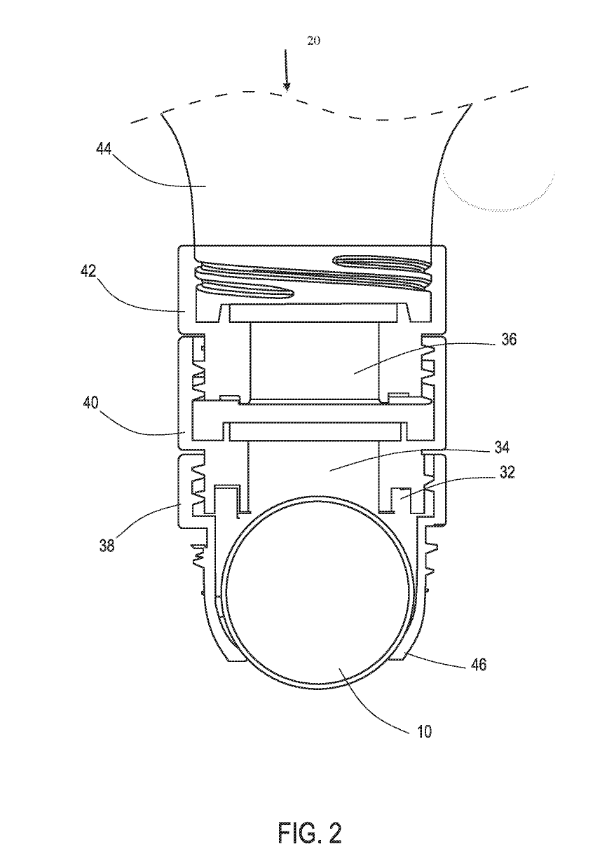

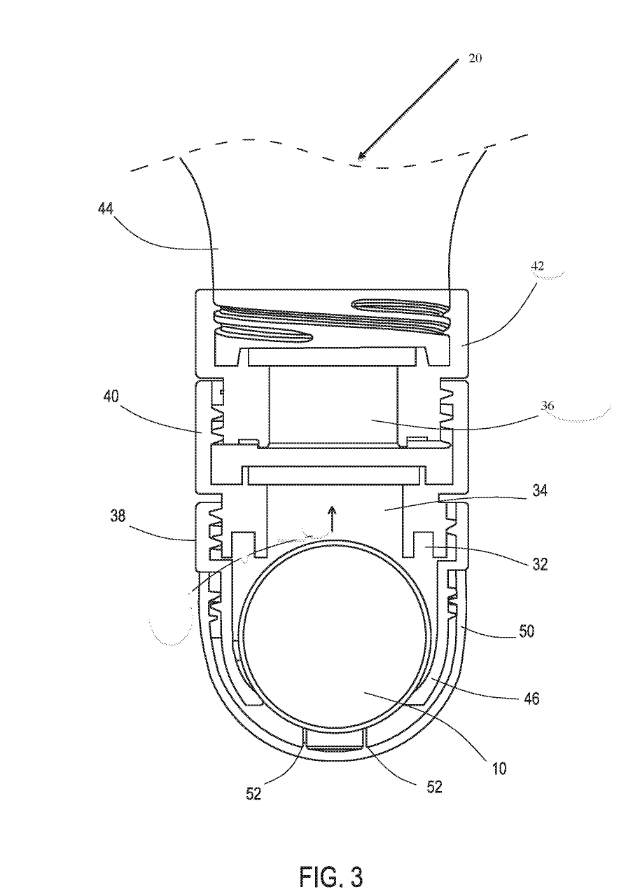

FIG. 1 is a view of how a pet 18 uses and operates the water bottle 20 cap adaptor dispenser 38, 40, 42 while the human owner holds the larger body of bottle 20 out to the pet 18 and his tongue 12. As shown in FIG. 1, the bottle 20 and cap adaptor dispenser 38, 40, 42 is held in an inverted or downward or vertical position with some slight angle comfortable for the pet 18 with the cap adaptor dispenser 38, 40, 42 and ball 10 closest to the mouth of the pet 18. Generally, the cap adaptor dispenser 38, 40, 42 and ball 10 is facing down at some angle to the ground and angle to the head of the pet 18. The pet's 18 tongue 12 has motion in both the horizontal direction 22 and vertical direction 24. The vertical motion 24 of the tongue 12 results in the ball 10 bobbing or bouncing in and out or up or down through the inner portion 34 allowing water to flow on to the surface of the ball 10 to the moving tongue 12. The horizontal motion 22 of the tongue 12 results in the ball 10 rolling in and out through the inner portion 34 and allowing water to flow out on to the surface of the ball 10 to the moving tongue 12. As is well known the motion of the tongue 12 of the pet 18 will go in and out of the mouth while drinking water therefore the ball will not be moved all the time during drinking. When the tongue 12 is not below and touching the ball 10, action of the water pressure from bottle 20 on the ball 10 held in place by a holding lip (46 of FIGS. 2 and 3) which closes off water flow. Therefore, water is not wasted while the tongue 12 is in the mouth.

Additionally, the plastic material used in the manufacture of the cap dispenser 38, 40, 42 or ball 10 may be impregnated with a substance having meat flavor or smell or combination thereof. This feature assists in persuading or enticing or training the pet 18 to touch and move the ball 10 with the pet's tongue.

In FIG. 1, while the dog's 18 tongue 12 is in vertical motion 24 and horizontal motion 22, bubbles 16 are created that flow upward to fill the emptying area at the inverted bottom of the bottle 20. The bubbles 16 are created because pushing up motion 24 and across motion 22 in FIGS. 1 and the structures 32 and 34 of FIG. 2. This action prevents the larger body portion of the bottle 20 from crushing and collapsing in on itself in FIG. 1. This is the situation that often happens when humans drink from the same type of bottle 20 when their mouth encloses the opening of the bottle 20 near the threads. This bubble motion 16 further increases good flow of water to the ball 10 and the dog's tongue 12.

In FIGS. 2 and 3, the dispersion ball 10 is prevented from dropping out of a sleeve section 38 by flange area or holding lip area 46. Holding lip 46 has a shape structure which allows the ball 10 to roll back and forth or bob up and down as shown by 22 and 24 in FIG. 1 but not fall out of the sleeve 38. The bottom ball sleeve section 40 has shapes or structures 32 that allow the ball 10 to roll tightly yet bounce or bob up down due to the open rectangular structures 32. The bottom ball sleeve section 40 is attached with threads to ball top sleeve section 38 or by glue.

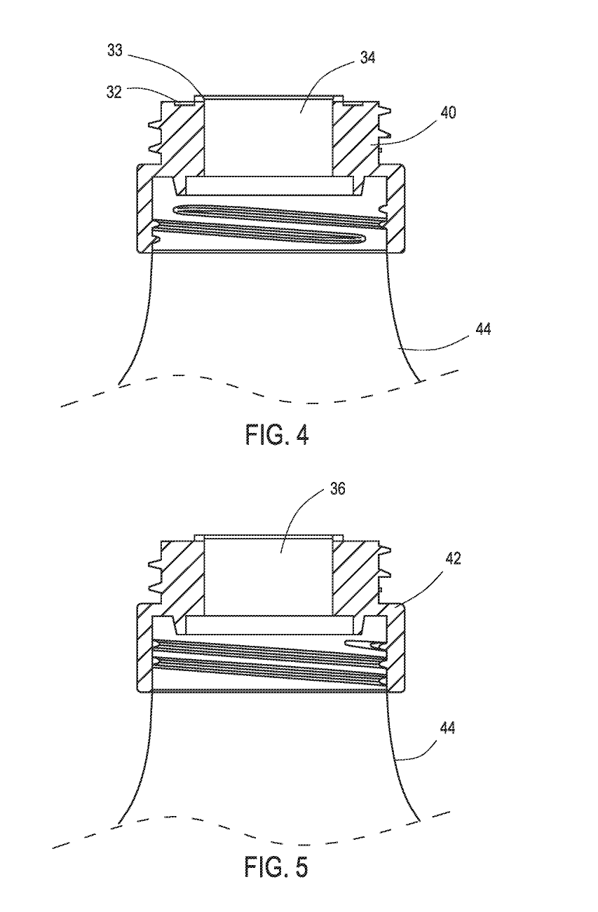

FIG. 4 shows in more close up detail of the open rectangular trench structures 32 and the contact surface 33 to the bottom of the ball 10. Either surface 33 or rectangular trench structure 32 can be made of softer plastic material than the rest of the adaptor sleeve sections 38 and 40 to the amount, which provides greater bounce or bobbing in the vertical motion of the ball 10. The surface 33 or trench 32 prevent the ball 10 from falling back into the bottle 20 when the animal 18 is licking. Also, the ball 10 may be made of softer plastic material than other areas of the sleeve sections 38 and 40 to the amount, which provides greater bounce or bobbing in the vertical motion of the ball 10.

In FIG. 2 or 4, as water flows through inner portions 34 and 36 of the top and bottom adaptor sleeves 38 and 40 and along the bottom surface and later the top surface of the ball 10 to the top structure 46, water will squeeze in and out of the circular trough or trench structures 32 in the bottom sleeve section 40 and inner portion 34.

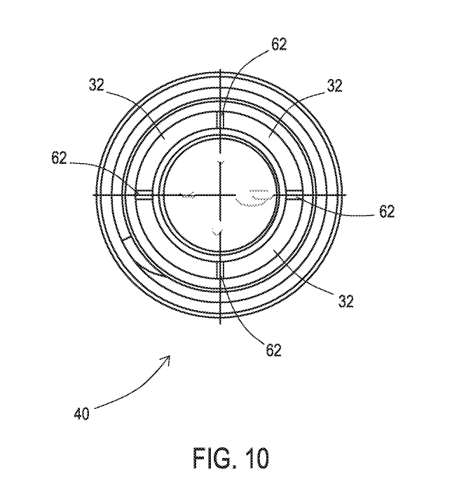

The circular trough feature is shown in further detail in FIG. 10, where at some points in the rectangular circular structure 32 four structures 62 are at a height that touches the ball 10 creating 4 rectangular trenches 32 that contain water. The top portion sleeve 38 is also round and has appropriate diameters so that it mates with the bottom sleeve section 40 with threads or glue. The squeezing of extra water will put pressure on the structures 32 touching the surface of the ball 10 and temporarily soften the structures 32 or force, or pressure extra water directly on the surface of the ball 10 to cause it to have extra bobbing or bounce motion and extra water flow through bottle 20.

FIGS. 3, 4 and 10 viewed together help understand the operation disclosed above.

Water runs from the bottle 20 in FIG. 1 through neck 44 in FIGS. 2 and 3, through inner sleeve well area 36 in adaptor 42 to inner sleeve well area 34 in bottom adaptor sleeve 40 to bottom surface of the dispersion ball 10 in the top sleeve 38, and flange area 46. Then as the ball 10 rolls and bounces water flows on to all surface of spherical ball 10. Additional water captured at the circular trough or trench 32 is at the same time provided or pressured to any or all surfaces of the ball 10 when rolling or bobbing because of the flange area 46 and the extra water flow.

In addition, it is possible to add some small space between the ball 10 and the structure 32 to provide bobbing or bounce motion as well as additional bobbing or bounce motion when used with the bobbing and bounce structure mentioned above. Any combination of the above bobbing and bounce structures and operations mentioned above may be used to provide various amounts of bobbing or bounce motions of the ball 10 and flow of water on to the surface of the ball 10.

In FIGS. 2 and 3, the bottle 20 threads are the ones normally used to attach a cap when humans open or close the cap to drink the water or store the water. The bottle cap dispenser 38, 40, 42 replaces that cap. The bottles 20 generally have either one of two size threads. A round adaptor sleeve 42 has appropriate bottom thread with diameter and slope to mate with threads at the bottom sleeve 40 having one of the two sizes of thread. The adaptor sleeve 42 has a top thread portion having a diameter and slope to match the threads of the other one of the two bottle thread sizes 20. Some common bottles 20 have cap thread diameters and slopes that match threads at the top of the bottom sleeve 40. In which case, the adaptor sleeve 42 is not used.

FIG. 3 shows the addition of the cap 50 that is threaded and removably attached top portion sleeve 38 at a location below the opening flange 46. The cap 50 is used when the flow of water on ball 10 is not needed and to protect the ball 10 and some of the outer portion of the top sleeve 38 and opening flange 46. FIG. 3 shows how the cap 50 covers the ball and stops the water flow via the pressure applied by the protrusions 52 in the cap 50 so the ball 10 does not roll or bounce or bob.

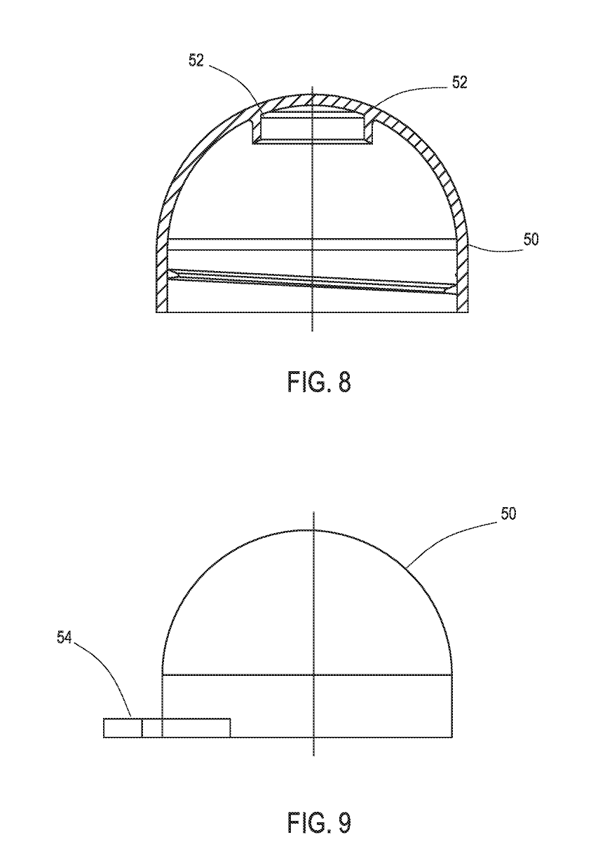

FIG. 8 shows a more detailed separate side view of the cap 50 with details on the location and position of the protrusions 52 pushing down on and holding the ball 10.

FIG. 4 shows a more detailed separate side view of the bottom sleeve 40 having inner portion 40 and circular trough 33 and 32 that touches or contacts the ball 10. In addition, FIG. 4 shows the direct threaded attachment of the bottom sleeve 40 to the bottle neck 44 of bottle 20 in FIG. 1 when the adaptor 42 in FIGS. 2 and 3 is not needed. For example, the bottle 20 used has threads that match the threads of the bottom sleeve 40.

FIG. 5 shows a more detailed separate side view of the adaptor sleeve 42 having inner portion 36. FIG. 5 shows the adaptor 42 threaded attached to the bottle neck 44 of the bottle 20 in FIG. 1.

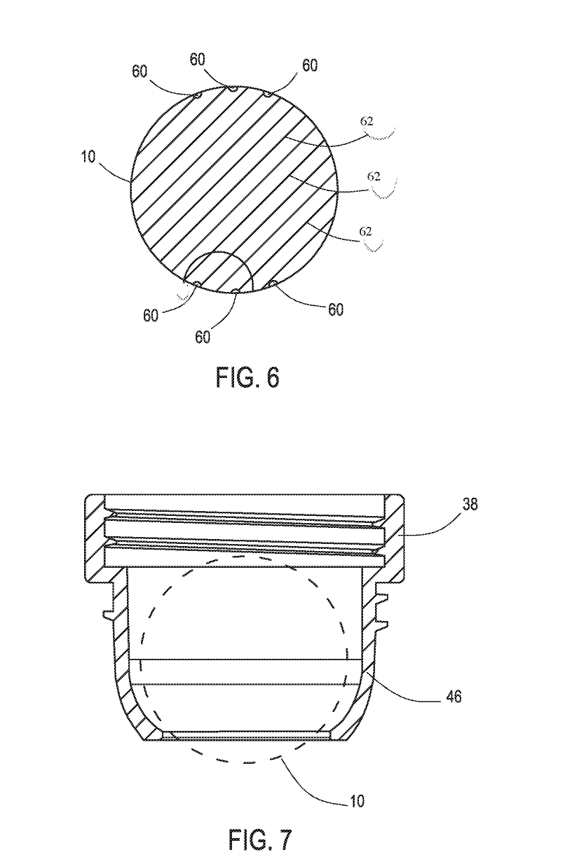

FIG. 6 shows a more detailed separate side view of the ball 10 having concaved dimples 60 distributed randomly about the ball 10. Lines 62, in FIG. 6, show the optional tiny cuts made in the ball 10 to provide further friction when the pet 18 tongue 12 moves the ball 10 vertically or horizontally n FIG. 1.

FIG. 7 shows a more detailed separate side view of the top sleeve 38 and flange 46 which hold top portion, or portion that the pet's 18 tongue 12 touches, of the ball 10 and which allows the ball 10 to move vertically or horizontally without the ball 10 ejected out of the bottle cap dispenser. Structures 32 in sleeve 34 in FIGS. 2 and 3 prevent the ball 10 from being ejected back inside bottle 20 through neck 44.

FIG. 9 shows a more detailed separate side view of the cap 50 having protrusion 54 from the outside structure for a hole to hold and thread a key chain through.

It should be understood that the devices is operated with the bottle and the cap dispenser pointed downward towards the pet 18 while being not necessarily perpendicular to the ground or earth. In the description above vertical and horizontal motions may have some small angle, which is due to aiming the ball for the comfortable position of the pet's 18 mouth.

While the present invention has been related in terms of the foregoing embodiments, those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A water bottle cap dispenser device, utilized in combination with a water bottle that includes a plurality of threads and a removable bottle cap comprising:
a bottom sleeve having threads to attach to the plurality of threads on the bottle that replaces the removable bottle cap, the bottom sleeve having an inner portion diameter a same size as an opening of the bottle and an upper portion having structures that touch and hold a bottom portion of a spherical ball and having circular trough structures that capture water as it flows downward through inner parts of the bottom sleeve to the ball when the bottle and ball is pointed to a pet's tongue;
a top sleeve having a second set of threads attached to a first set of threads on an outer part of the bottom sleeve, the top sleeve having a top round flange to hold a top portion of the ball through a round opening in the top sleeve and holding the ball against the structures that touch a bottom portion of the ball, while allowing the ball to roll around when horizontal motion is applied by a tongue of a pet allowing water flow around the surface of the ball;
water flows from the bottle through the inner portion of the bottom sleeve and an inner portion of the top sleeve and to the bottom surface of the ball while a further vertical motion of the tongue is applied causing water to squeeze in and out of the trough portion which then causes vertical bounce motion of the ball.

2. The water bottle cap dispenser device according to claim 1, wherein; the circular trough structures and structures that touch and hold the bottom portion of the ball are made of softer plastic material to allow more vertical bounce motion of the ball.

3. The water bottle cap dispenser device according to claim 1, wherein; the circular trough structures and structures that touch the bottom portion of the ball do not always touch the bottom portion of the ball so that the space created allows more vertical bounce motion of the ball.

4. The water bottle cap dispenser device according to claim 1, wherein; an adaptor sleeve having upper thread outer structure to match the threads of the bottom sleeve threads and having lower thread outer structure to match threads of the bottle having different thread size and having inner portion for water to flow into the bottom sleeve.

5. The water bottle cap dispenser device according to claim 2, wherein; an adaptor sleeve having upper thread outer structure to match the threads of the bottom sleeve threads and having lower thread outer structure to match threads of the bottle having different thread size and having inner portion for water to flow into the bottom sleeve.

6. The water bottle cap dispenser device according to claim 1, wherein concave shaped dimples are provided on the ball to increase surface area of the ball to contain more water on the ball to reach the tongue of the pet while the ball is rolling or bouncing.

7. The water bottle cap dispenser device according to claim 1, wherein a cap having threads is threadablly attached to a second set of threads of the top sleeve located below the opening for the ball.

8. The water bottle cap dispenser device according to claim 7, wherein the cap includes a tab structure at one side having an aperture that receives a key chain.

9. The water bottle cap dispenser device according to claim 8, wherein the cap includes a vertical protrusion structure to put pressure on the ball when the cap is screwed down to further contain the water when the ball is capped.

10. The water bottle cap dispenser device according to claim 1, wherein the top and bottom sleeves are all one piece having no threads to join them.

11. The water bottle cap dispenser device according to claim 1, wherein the plastic material of the cap dispenser or the ball is impregnated with a substance having meat flavor or smell or combination thereof.

12. A water bottle cap dispenser device, utilized in combination with a water bottle that includes a plurality of threads and a removable bottle cap comprising:
a bottom sleeve having threads to attach to the plurality of threads on the bottle that replaces the removable bottle cap, the bottom sleeve having an inner portion diameter a same size as an opening of the bottle and an upper portion having structures that touch and hold a bottom portion of a spherical ball and having circular trough structures that capture water as it flows downward through inner parts of the bottom sleeve to the ball when the bottle is pointed to a pet's tongue;
a top sleeve having a second set of threads attached to a first set of threads on an outer part of the bottom sleeve, the top sleeve having a top round flange to hold a top portion of the ball through a round opening and holding the ball against the structures that touch a bottom portion of the ball, while allowing the ball to roll around when horizontal motion is applied by a tongue of a pet allowing water flow around the surface of the ball;
water flows from the bottle through the inner portion of the bottom sleeve and an inner portion of the top sleeve and to the bottom surface of the ball while a further vertical motion of the tongue is applied causing water to squeeze in and out of the trough portion which then causes vertical bounce motion of the ball
the circular trough structures and the structures that touch and hold the bottom portion of the ball are made of softer plastic material to allow more vertical bounce motion of the ball.

13. The water bottle cap dispenser device according to claim 12, wherein; an adaptor sleeve having upper thread outer structure to match the threads of the bottom sleeve threads and having lower thread outer structure to match threads of the bottle having different thread size and having inner portion for water to flow into the bottom sleeve.

14. The water bottle cap dispenser device according to claim 12, wherein concave shaped dimples are provided on the ball to increase surface area of the ball to contain more water on the ball to reach the tongue of the pet while the ball is rolling or bouncing.

15. The water bottle cap dispenser device according to claim 12, wherein a cap having threads is threadablly attached to a second set of threads of the top sleeve located below the opening for the ball.

16. The water bottle cap dispenser device according to claim 15, wherein the cap includes a tab structure at one side having an aperture that receives a key chain.

17. The water bottle cap dispenser device according to claim 16, wherein the cap includes a vertical protrusion structure to put pressure on the ball when the cap is screwed down to further contain the water when the ball is capped.

18. The water bottle cap dispenser device according to claim 12, wherein the top and bottom sleeves are all one piece having no threads to join them.

19. The water bottle cap dispenser device according to claim 12, wherein the plastic material of the cap dispenser or the ball is impregnated with a substance having meat flavor or smell or combination thereof.

20. A water bottle cap dispenser device, utilized in combination with a water bottle that includes a plurality of threads and a removable bottle cap comprising:
a bottom sleeve having threads to attach to the plurality of threads on the bottle that replaces the removable bottle cap, the bottom sleeve having an inner portion diameter a same size as an opening of the bottle and an upper portion having structures that touch and hold a bottom portion of a spherical ball and having circular trough structures that capture water as it flows downward through inner parts of the bottom sleeve to the ball when the bottle is pointed to a pet's tongue;
a top sleeve having a second set of threads attached to a first set of threads on an outer part of the bottom sleeve, the top sleeve having a top round flange to hold a top portion of the ball through a round opening and holding the ball against the structures that touch a bottom portion of the ball, while allowing the ball to roll around when horizontal motion is applied by a tongue of a pet allowing water flow around the surface of the ball;
water flows from the bottle through the inner portion of the sleeve and to the bottom surface of the ball while a further vertical motion of the tongue is applied causing water to squeeze in and out of the trough portion which then causes vertical bounce motion of the ball
the circular trough structures and the structures that touch and hold the bottom portion of the ball are made of softer plastic material to allow more vertical bounce motion of the ball;
an adaptor sleeve having upper thread outer structure to match the threads of the bottom sleeve threads and having lower thread outer structure to match threads of the bottle having different thread size and having inner portion for water to flow into the bottom sleeve.

21. The water bottle cap dispenser device according to claim 20, a cap having threads is threadablly attached to a second set of threads of the top sleeve located below the opening for the ball;
the cap includes a tab structure at one side having an aperture that receives a key chain;
wherein the cap includes a vertical protrusion structure to put pressure on the ball when the cap is screwed down to further contain the water when the ball is capped.

22. The water bottle cap dispenser device according to claim 20, wherein concave shaped dimples are provided on the ball to increase surface area of the ball to contain more water on the ball to reach the tongue of the pet while the ball is rolling or bouncing.

23. The water bottle cap dispenser device according to claim 20, wherein the plastic material of the cap dispenser or the ball is impregnated with a substance having meat flavor or smell or combination thereof.
